(19) United States
(12) Patent Application Publication
(10) Pub. No.: US 2016/0161794 A1
(43) Pub. Date: Jun. 9, 2016

(54) DISPLAY DEVICE AND MANUFACTURING METHOD THEREOF

(71) Applicant: SAMSUNG DISPLAY CO., LTD., Yongin-si (KR)

(72) Inventors: Si Kwang KIM, Daegu (KR); Tae Woon CHA, Seoul (KR)

(21) Appl. No.: 14/927,035

(22) Filed: Oct. 29, 2015

(30) Foreign Application Priority Data
Dec. 4, 2014 (KR) 10-2014-0173325

(51) Int. Cl. G02F 1/1333; G02F 1/1335; G02F 1/1337; G02F 1/1368

(52) U.S. Cl. CPC G02F 1/133377; G02F 1/1368; G02F 1/133514; G02F 1/133512; G02F 1/133516; G02F 1/1337

(57) ABSTRACT

According to an exemplary embodiment of the present system and method, a display device includes: a substrate including a plurality of pixel areas and a thin film transistor region; a plurality of thin film transistors formed on the substrate; a pixel electrode formed in each of the pixel areas and connected to a corresponding thin film transistor; a color filter layer formed on the pixel electrode to be spaced apart from the pixel electrode by a microcavity disposed in between; a plurality of connection microcavities formed in the thin film transistor region and connecting microcavities in a column; and a liquid crystal material filling the microcavities and the connection microcavities.

### CROSS-REFERENCE TO RELATED APPLICATION

This application claims priority to and the benefit of Korean Patent Application No. 10-2014-0173325 filed in the Korean Intellectual Property Office on Dec. 4, 2014, the entire contents of which are incorporated herein by reference.

### BACKGROUND

(a) Field

The present disclosure relates to a display device and a manufacturing method thereof.

(b) Description of the Related Art

A liquid crystal display generally is a flat panel display and includes two sheets of display panels in which field generating electrodes, such as a pixel electrode and a common electrode, are formed and a liquid crystal layer interposed in between. The liquid crystal display applies a voltage to the field generating electrode to generate an electric field in the liquid crystal layer. The generated electric field determines the orientation of the liquid crystal molecules in the liquid crystal layer, which affects the polarization of incident light of the liquid crystal layer. Thus, by controlling the electric field, the liquid crystal display controls the polarization of incident light, thereby displaying an image.

Two sheets of display panels configuring the liquid crystal display may include a thin film transistor array panel and a counter display panel. The thin film transistor array panel may be formed with gate lines transferring gate signals, data lines transferring data signals and intersecting the gate lines, thin film transistors connected to the gate lines and the data line, pixel electrodes connected to the thin film transistors, and the like. The counter display panel may be formed with a light blocking member, a color filer, a common electrode, and the like. In some cases, a thin film transistor array panel may be formed with the light blocking member, the color filter, and the common electrode.

However, in the liquid crystal display according to the related art, two sheets of substrates are essentially used and each component of the liquid crystal display is formed on the two sheets of substrates. As a result, the display device may be heavy, thick, and expensive. Furthermore, the manufacturing process time may be long.

The above information disclosed in this Background section is only for enhancement of understanding of the background of the present system and method, and therefore, it may contain information that does not form the prior art that is already known in this country to a person of ordinary skill in the art.

### SUMMARY

The present disclosure provides a display device manufactured using a single substrate, which provides advantages of reduced weight, thickness, cost, and processing time, and a manufacturing method thereof.

An exemplary embodiment of the present disclosure provides a display device including: a substrate including a plurality of pixel areas and a thin film transistor region; a plurality of thin film transistors formed on the substrate; a pixel electrode formed in each of the pixel areas and to a corresponding thin film transistor; a color filter layer formed on the pixel electrode to be spaced apart from the pixel electrode by a microcavity disposed in between; a plurality of connection microcavities formed in the thin film transistor region and connecting microcavities in a column; and a liquid crystal material filling the microcavities and the connection microcavities.

The plurality of pixel areas may each include the plurality of microcavities, and the plurality of microcavities may be each spaced apart from each other by at least one of a first valley formed in an extending direction of a gate line and a second valley formed in an extending direction of a data line.

The connection microcavities may be formed only in the first valley.

A width of the connection microcavity may be ½ to ¼ of the width of the microcavity, the widths measured along a direction in which the first valley extends.

A side of a microcavity not connected to a connection microcavity may be provided with an injection hole.

The display device may further include an alignment layer formed in the microcavities.

The alignment layer may be lumped in the connection microcavities.

The display device may further include a common electrode formed under the color filter layer, wherein the common electrode may be spaced apart from the pixel electrode by a microcavity disposed in between.

A region where a connection microcavity is formed may be provided with a light blocking member.

The color filter layer may include a plurality of color filters. The color filters formed in a column may have the same color and may be formed over microcavities that are connected to each other. Adjacent color filters formed in a row have different colors and are formed over microcavities that are not connected to each other.

Another embodiment of the present system and method provides a manufacturing method of a display device including: forming a plurality of thin film transistors on a substrate; forming a first insulating layer on the thin film transistors; forming a plurality of pixel electrodes on the first insulating layer, each pixel electrode connected to a corresponding one of the thin film transistors; forming a sacrificial layer on the pixel electrodes, the sacrificial layer includes a plurality of column portions each having a wide width and a narrow width repeated in a column direction of the substrate and formed to be separated from each other in a row direction; forming a color filter layer on the sacrificial layer; forming a liquid crystal injection hole to expose the sacrificial layer by patterning the color filter layer; forming a microcavity between each of the pixel electrodes and the color filter layer by removing the sacrificial layer and forming a connection microcavity in a region where the pixel electrodes are not formed; forming an alignment layer by injecting an alignment layer material into the microcavities; forming a liquid crystal layer by injecting a liquid crystal material into the microcavities; and sealing the microcavities by forming an encapsulation layer on the color filter layer, wherein the microcavities positioned in a column are connected to each other by the connection microcavity.

The microcavities may be each spaced apart from each other by at least one of a first valley formed in an extending direction of a gate line and a second valley formed in an extending direction of a data line, and the connection microcavity may connect the microcavities that are adjacent to each other in a column direction and may be formed in the first valley.

The narrow width of the sacrificial layer may be ½ to ¼ of the wide width of the sacrificial layer.

A width of a connection microcavity may be ½ to ¼ of a width of the microcavity, the widths being measured along a direction in which the first valley extends.

In the forming of the alignment layer by injecting the alignment layer material into the microcavities, the alignment layer material injected into the microcavity may flow in the connection microcavity.

The forming of the alignment layer by injecting the alignment layer material into the microcavity may include hardening the alignment layer material after injecting the alignment layer material, and the alignment layer may be lumped in the connection microcavity.

In the forming of the color filter layer on the sacrificial layer, color filters having the same color may be formed on a same column portion of the sacrificial layer the column direction, and the color filters having different colors may be formed on adjacent column portions of the sacrificial layer in the row direction.

In the forming of the liquid crystal layer by injecting a liquid crystal material into the microcavities, the liquid crystal material may be injected along the row direction of the microcavities arranged in a matrix direction, and the liquid crystal material maybe dropped into either even numbered first valleys or odd numbered first valleys.

As set forth above, the display device and the manufacturing method thereof according to exemplary embodiments of the present system and method have the following effects.

According to exemplary embodiments of the present system and method, it is possible to reduce the weight, the thickness, the cost, and the process time by manufacturing the display device using a single substrate.

Further, according exemplary embodiments of the present system and method, it is possible to prevent the structures such as the color filter positioned on the microcavity from sinking and induce lumping of the alignment layers into the connection microcavity by connecting microcavities adjacent in the column direction of each pixel area using a connection microcavity.

### BRIEF DESCRIPTION OF THE DRAWINGS

FIG. 1 is a plan view of a display device according to an exemplary embodiment of the present system and method.

FIG. 2 is a plan view of one pixel of the display device according to an exemplary embodiment of the present system and method.

FIG. 3 is a cross-sectional view of a portion of the display device taken along the line III-III of FIG. 1 according to an exemplary embodiment of the present system and method.

FIG. 4 is a cross-sectional view of a portion of the display device taken along the line IV-IV of FIG. 1 according to an exemplary embodiment of the present system and method.

FIG. 5 is a cross-sectional view of a portion of the display device taken along the line V-V of FIG. 1 according to an exemplary embodiment of the present system and method.

FIG. 6 is a layout view of a display device according to a comparative example.

FIG. 7 is a cross-sectional view of the layout view of FIG. 6 taken along the line VII-VII.

FIG. 8 is an image illustrating a state in which a liquid crystal material escaped from the display device according to the comparative example of FIG. 6.

FIG. 9 is an image illustrating a state in which air bubbles are generated when the liquid crystal material is injected in the display device according to the comparative example of FIG. 6.

FIGS. 10, 12, 14, 16, 18, 21, 22, and 23 are process cross-sectional views of a surface of the display device of FIG. 1 taken along the line V-V.

FIGS. 11, 13, 15, 17, 19, 25, 27, and 29 are process cross-sectional views of a surface of the display device of FIG. 1 taken along the line XI-XI.

FIG. 20 is a diagram illustrating a form of a sacrificial layer over a substrate according to an exemplary embodiment of the present system and method.

FIGS. 24, 26, 28, 30, 33, and 36 are process cross-sectional views of a surface of the display device of FIG. 1 taken along the line III-III.

FIGS. 31, 32A, 32B, 32C, and 32D are diagrams illustrating a process of applying an alignment solution, drying an alignment layer, and inducing agglomeration of the alignment layer in a manufacturing method of a display device according to an exemplary embodiment of the present system and method.

FIGS. 34, 35A, 35B, 35C, and 35D are diagrams illustrating a process of injecting a liquid crystal material in the manufacturing method of a display device according to an exemplary embodiment of the present system and method.

### DETAILED DESCRIPTION OF THE EMBODIMENTS

The present system and method are described with reference to the accompanying drawings in which exemplary embodiments of the present system and method are shown. Those of ordinary skill in the art would realize that the described embodiments may be modified in various different ways without departing from the spirit or scope of the present system and method.

In the drawings, the thickness of layers, films, panels, regions, etc., are exaggerated for clarity. Like reference numerals designate like elements throughout the specification. When an element such as a layer, film, region, or substrate is referred to as being “on” another element, it can be directly on the other element or intervening elements may also be present. In contrast, when an element is referred to as being “directly on” another element, there are no intervening elements present. Terms indicating directions, positions, and/or orientations of elements generally have the frame of reference of the corresponding figures in which the elements are shown.

Hereinafter, a display device according to an exemplary embodiment of the present system and method is schematically described.

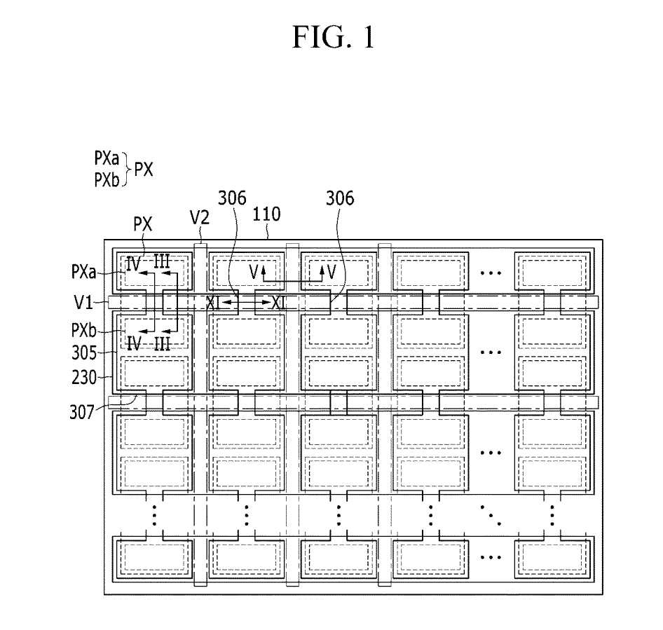

FIG. 1 is a plan view of a display device according to an exemplary embodiment of the present system and method. For convenience, FIG. 1 illustrates only some components of the display device.

The display device of FIG. 1 includes a substrate 110, which may be made of a material such as glass, plastic, and the like, and a plurality of color filters 230 formed on the substrate 110.

The substrate 110 includes a plurality of pixel areas PXs. The plurality of pixel areas PXs may be disposed in a matrix form that includes a plurality of pixel rows and a plurality of pixel columns. Each pixel area PX may include a first subpixel area PXa and a second subpixel area PXb. The first subpixel area PXa and the second subpixel area PXb may be disposed vertically adjacent to one another.

A first valley V1 may be disposed between the first subpixel area PXa and the second subpixel area PXb along a pixel row direction. A second valley V2 may be disposed between adjacent pixel columns of the plurality of pixel columns.

The plurality of color filters 230 is formed in pixel row and pixel column directions. In this case, the first valley V1 is provided with an injection hole 307 through which a portion of a color filter 230 is removed to expose components positioned under the color filter 230.

In this case, the color filters 230 formed in the pixel column direction may represent the same color, and adjacent color filters 230 formed in the pixel row direction may represent different colors. That is, in FIG. 1, color filters formed in a vertical direction may represent the same color, and color filters adjacently formed in a horizontal direction, having a second valley V2 disposed in between, may represent different colors. In this case, red, green, and blue color filters may be sequentially arranged repeatedly.

Each color filter 230 is formed to be separated from the substrate 110 between the adjacent second valleys V2 to form a microcavity 305. Further, each color filter 230 is formed to be attached to the substrate 110 in the second valley V2 so as to cover both sides of the microcavity 305.

The above-described structure of the display device is an exemplary embodiment of the present system and method and therefore may be variously changed. For example, the manner in which the pixel area PX, the first valley V1, and the second valley V2 are disposed may be changed, and the plurality of color filters 230 may be connected to each other in the first valley V1.

That is, referring to FIG. 1, adjacent color filters in a pixel column may be connected to each other in the first valley V1 by a connection microcavity 306 in which the color filter 230 is formed to be separated from the substrate in the first valley V1. The connection microcavity 306 connects adjacent microcavities 305 in the pixel column direction.

Next, one pixel of the display device according to an exemplary embodiment of the present system and method is described with reference to FIGS. 1 to 4.

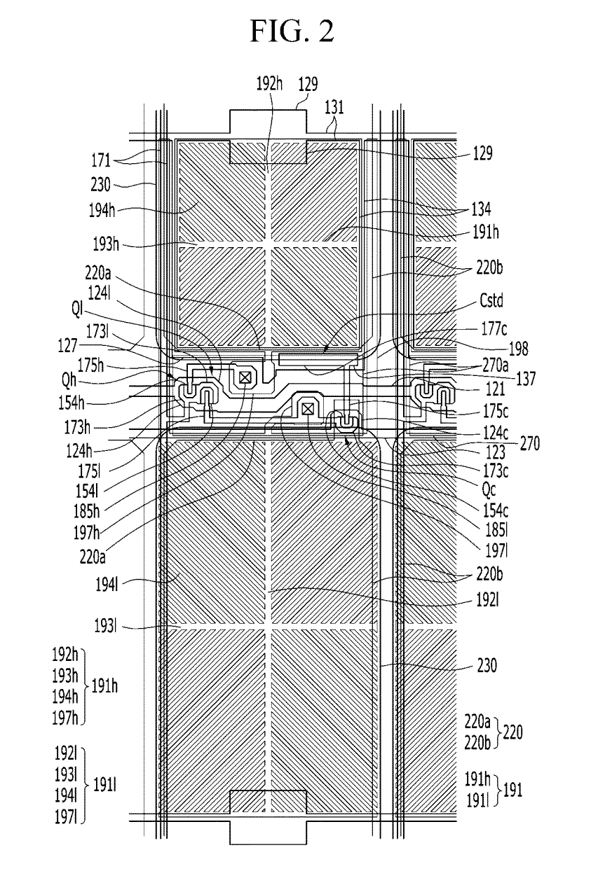

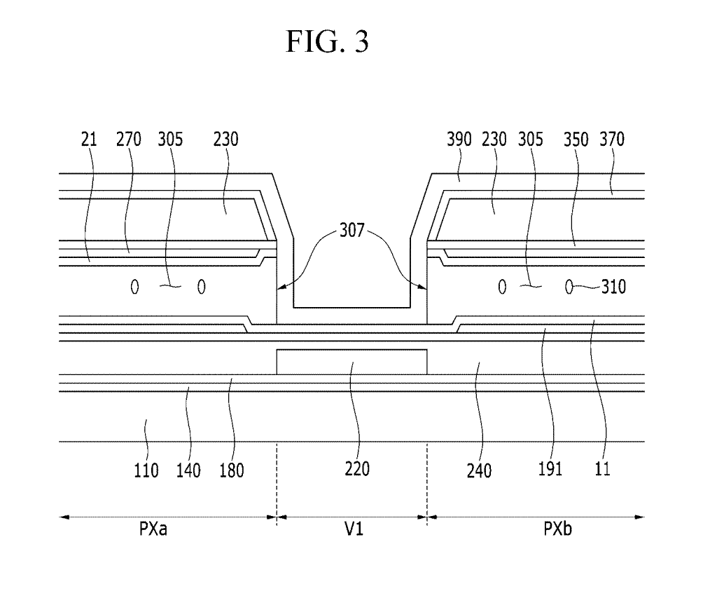

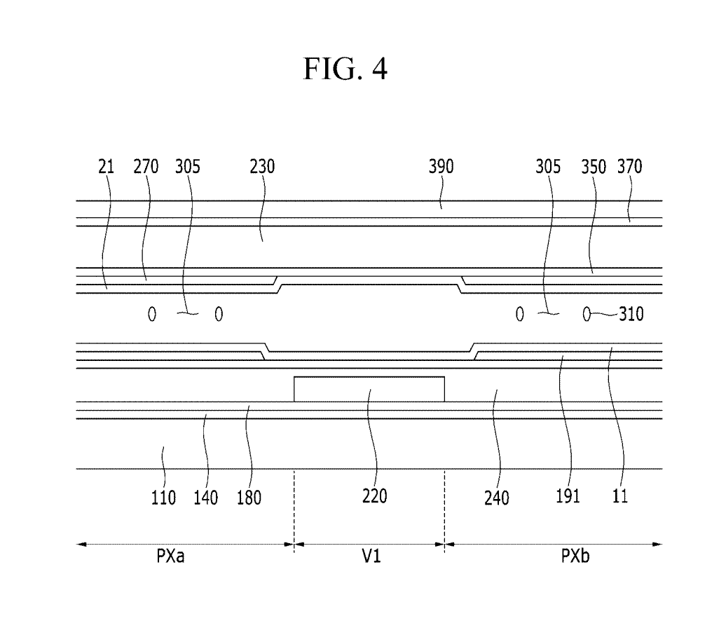

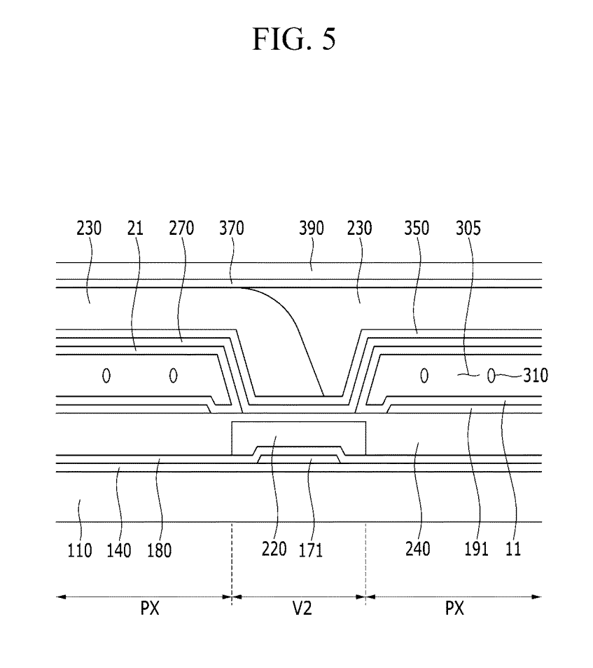

FIG. 2 is a plan view of one pixel of the display device according to an exemplary embodiment of the present system and method. FIG. 3 is a cross-sectional view of a portion of the display device taken along the line III-III of FIG. 1 according to an exemplary embodiment of the present system and method. FIG. 4 is a cross-sectional view of a portion of the display device taken along the line IV-IV of FIG. 1 according to an exemplary embodiment of the present system and method. FIG. 5 is a cross-sectional view of a portion of the display device taken along the line V-V of FIG. 1 according to an exemplary embodiment of the present system and method.

Referring to FIGS. 1 to 5, a plurality of gate conductors including a plurality of gate lines 121, a plurality of step down gate lines 123, and a plurality of sustain electrode lines 131 are formed on the substrate 110.

Referring to FIG. 2, the gate line 121 and the step down gate line 123 mainly extend in a horizontal direction to transfer the gate signals. The gate conductor further includes a first gate electrode 124h protruding upward, a second gate electrode 124l protruding downward from the gate line 121, and a third gate electrode 124c protruding upward from the step down gate line 123. The gate electrode 124h and the second gate electrode 124l are connected to each other to form one protrusion. The manner in which the first, second and third gate electrodes 124h, 124l, and 124c are arranged or protrude may be varied.

The sustain electrode line 131 mainly extends in the horizontal direction to transfer a defined voltage such as a common voltage Vcom. The sustain electrode line 131 includes a sustain electrode 129 that protrudes upward and downward, a pair of vertical parts 134 that extends substantially vertically downward to the gate lines 121, and a horizontal part 127 that connects ends of the pair of vertical parts 134 to each other. The horizontal part 127 includes a capacitive electrode 137 that extends downward.

Referring to FIG. 3, a gate insulating layer 140 is formed on the gate conductors 121, 123, 124h, 124l, 124c, and 131. The gate insulating layer 140 may be made of inorganic insulating materials such as silicon nitride (SiNx) and silicon oxide (SiOx). Further, the gate insulating layer 140 may be formed of a single layer or multilayers.

A first semiconductor 154h, a second semiconductor 154l, and a third semiconductor 154c are formed on the gate insulating layer 140. The first semiconductor 154h may be positioned on a first gate electrode 124h, the second semiconductor 154l may be positioned on a second gate electrode 124l, and the third semiconductor 154c may be positioned on a third gate electrode 124c. The first semiconductor 154h and the second semiconductor 154l may be connected to each other, and the second semiconductor 154l and the third semiconductor 154c may be connected to each other. Further, the first semiconductor 154h may also be formed by extending below data lines 171. The first to third semiconductors 154h, 154l, and 154c may be made of amorphous silicon, polycrystalline silicon, metal oxide, and the like.

An ohmic contact (not illustrated) may be further formed on the first to third semiconductors 154h, 154l, and 154c, respectively. The ohmic contact (not illustrated) may be made of a material such as n+ hydrogenated amorphous silicon, which is doped with silicide or n-type impurities at high concentration.

A data conductor including the data line 171, a first source electrode 173h, a second source electrode 173l, a third source electrode 173c, a first drain electrode 175h, a second drain electrode 175l, and a third drain electrode 175c is formed on the first to third semiconductors 154h, 154l, and 154c.

The data line 171 transfers a data signal and mainly extends in a vertical direction to intersect the gate lines 121 and the step down gate lines 123. Each data line 171 includes the first source electrode 173h and the second source electrode 173l, which extend toward the first gate electrode 124h and the second gate electrode 124l, respectively, and are connected to each other.

Each of the first drain electrode 175h, the second drain electrode 175l, and the third drain electrode 175c includes a wide tip portion and a bar-shaped tip portion. The bar-shaped tip portion of the first drain electrode 175h and the second drain electrode 175l is partially enclosed by the first source electrode 173h and the second source electrode 173l, respectively. The wide tip portion of the second drain electrode 175l may also have an extended portion that forms the third source electrode 173c, which is bent in a ‘U’-letter shape. The wide tip portion 177c of the third drain electrode 175c overlaps the capacitive electrode 137 to form a buck capacitor Cstd, and the bar-shaped tip portion thereof is partially enclosed by the third source electrode 173c.

The first gate electrode 124h, the first source electrode 173h, the first drain electrode, 175h and the first semiconductor 154h together form a first thin film transistor Qh. The second gate electrode 124l, the second source electrode 173l, the second drain electrode 175l, and the second semiconductor 154l together form a second thin film transistor Ql. The third gate electrode 124c, third source electrode 173c, the third drain electrode 175c, and the third semiconductor 154c together form a third thin film transistor Qc.

The first semiconductor 154h, the second semiconductor 154l, and the third semiconductor 154c may be connected to one another and form in a linear shape. The linear shape may overlap with the data conductors 171, 173h, 173l, 173c, 175h, 175l, and 175c and the ohmic contacts positioned thereunder, as well as with channel regions between the source electrodes 173h, 173l, and 173c and the drain electrodes 175h, 175l, and 175c.

A portion of the first semiconductor 154h between the first source electrode 173h and the first drain electrode 175h is exposed by not being covered with the first source electrode 173h and the first drain electrode 175h. A portion of the second semiconductor 154l between the second source electrode 173l and the second drain electrode 175l is exposed by not being covered with the second source electrode 173l and the second drain electrode 175l. A portion of the third semiconductor 154c between the third source electrode 173c and the third drain electrode 175c is exposed by not being covered with the third source electrode 173c and the third drain electrode 175c.

A passivation layer 180 is formed on portions of the semiconductors 154h, 154l, and 154c that are exposed and not covered by the data conductors 171, 173h, 173l, 173c, 175h, 175l, and 175c, each source electrode 173h/173l/173c, and each source electrode 175h/175l/175c. The passivation layer 180 may be made of an organic insulating material or an inorganic insulating material and may be formed of a single layer or multilayers.

A light blocking member 220 is formed on the passivation layer 180. The light blocking member 220 may be formed on a boundary part of the pixel area PX and the thin film transistor to prevent light from leaking. Also, the light blocking member 220 may be formed between the first subpixel area PXa and the second subpixel area PXb.

The light blocking member 220 includes a horizontal light blocking member 220a and a vertical light blocking member 220b. The horizontal light blocking member 220a is expanded upward and downward by extending along the gate line 121 and the step down gate line 123 and covers a region in which the first thin film transistor Qh, the second thin film transistor Ql, the third thin film transistor Qc, and the like are positioned. The vertical light blocking member 220b extends along the data line 171. That is, the horizontal light blocking member 220a may be formed in the first valley V1, and the vertical light blocking member 220b may be formed in the second valley V2.

A first insulating layer 240 may be further formed on the light blocking member 220. The first insulating layer 240 may be made of inorganic insulating materials such as silicon nitride (SiNx), silicon oxide (SiOx), and silicon nitride oxide (SiOxNy). The first insulating layer 240 serves to protect the light blocking member 220 made of an organic material, and may be omitted in some cases.

The first insulating layer 240, the light blocking member 220, and the passivation layer 180 are provided with a plurality of first contact holes 185h and a plurality of second contact holes 185l, which expose the wide tip portion of the first drain electrode 175h and the wide tip portion of the second drain electrode 175l, respectively.

A pixel electrode 191 is formed on the first insulating layer 240. The pixel electrode 191 may be made of transparent metal materials such as indium tin oxide (ITO) and indium zinc oxide (IZO).

The pixel electrode 191 includes a first subpixel electrode 191h and a second subpixel electrode 191l that are separated from each other by the gate line 121 and the gate line 123 disposed in between. As FIG. 2 shows, the first subpixel electrode 191h is disposed in the portion of the pixel area PX above the gate line 121 and the step down gate line 123, and the second subpixel electrode 191l is disposed in the portion of the pixel area PX below the gate line 121 and the step down gate line 123. The first subpixel electrode 191h and the second subpixel electrode 191l are disposed adjacent to each other in a column direction. That is, the first subpixel electrode 191h and the second subpixel electrode 191l are separated from each other by the first valley V1 disposed in between, and the first subpixel electrode 191h is positioned in the first subpixel area PXa, and the second subpixel electrode 191l is positioned in the second subpixel area PXb.

The first subpixel electrode 191h and the second subpixel electrode 191l are each connected to the first drain electrode 175h and the second drain electrode 175l through the first contact hole 185h and the second contact hole 185l, respectively. Therefore, when the first thin film transistor Qh and the second thin film transistor Ql are in a turn-on state, the first thin film transistor Qh and the second thin film transistor Ql are applied with a data voltage from the first drain electrode 175h and the second drain electrode 175l.

The overall shape of each of the first subpixel electrode 191h and the second subpixel electrode 191l is a quadrangle. Each of the first subpixel electrode 191h and the second subpixel electrode 191l includes a cruciform stem part. The cruciform stem part of the first subpixel electrode 191h has a horizontal stem part 193h and a vertical stem part 192h intersecting the horizontal stem part 193h. Similarly, the cruciform stem part of the second subpixel electrode 191l has a horizontal stem part 193l and a vertical stem part 192l intersecting the horizontal stem part 193l. Further, the first subpixel electrode 191h and the second subpixel electrode 191l include a plurality of fine branch parts 194h and 194l and protrusions 197h and 197l which protrude downward or upward from edge sides of the subpixel electrodes 191h and 191l, respectively.

Each of the first and second subpixel electrodes 191h and 191l is divided into four sub-regions by the horizontal stem parts 193h and 193l and the vertical stem parts 192h and 192l, respectively. The fine branch parts 194h and 194l obliquely extend from the horizontal stem parts 193h and 193l and the vertical stem parts 192h and 192l, respectively, in a direction that may form an angle of approximately 45° or 135° with respect to the gate line 121 or the horizontal stem parts 193h and 193l. Further, the directions in which the fine branch parts 194h and 194l of two adjacent sub regions extend may be orthogonal to each other.

According to an exemplary embodiment of the present system and method, the first subpixel electrode 191h further includes an outside stem part that encloses other parts thereof, and the second subpixel electrode 191l further includes horizontal parts positioned at an upper portion and a lower portion and left and right vertical parts 198 positioned at the left and right of the first subpixel electrode 191h. The left and right vertical parts 198 may prevent capacitive coupling between the data line 171 and the first subpixel electrode 191h.

The manner in which the pixel area is disposed, the structure of the thin film transistor, and the shape of the pixel electrode are only provided above as an example. The present system and method are not limited thereto and may be variously changed.

A common electrode 270 is formed on the pixel electrode 191, while being spaced apart from the pixel electrode 191 at a predetermined distance. A microcavity 305 is formed between the pixel electrode 191 and the common electrode 270. That is, the microcavity 305 is enclosed by the pixel electrode 191 and the common electrode 270. The width of the microcavity 305 may be variously changed depending on the size and resolution of the display device.

The common electrode 270 may be made of transparent metal materials such as indium tin oxide (ITO) and indium zinc oxide (IZO). The common electrode 270 may be applied with a constant voltage, and an electric field may be formed between the pixel electrode 191 and the common electrode 270.

As FIG. 2 shows, the connection microcavity 306 is also formed in the first valley V1. The width of the connection microcavity 306 is narrower than that of the microcavity 305 and is generally aligned with the center of the microcavity 305. The width of the connection microcavity 306 may be ½ to ¼ of the horizontal width of the microcavity 305.

FIG. 3 is a cross section of a portion of the display device excluding the connection microcavity 306. FIG. 4 is a cross section of a portion of the display device including the connection microcavity 306. Referring to FIG. 4, the connection microcavity 306 connects adjacent microcavities 305 are positioned on both sides of the first valley V1. A portion of the microcavity 305 not connected to the connection microcavity 306 may be provided with an injection hole that allows an alignment layer material and a liquid crystal material to be injected into the microcavity 305.

A first alignment layer 11 is formed on the pixel electrode 191. The first alignment layer 11 may also be formed on portions of the first insulating layer 240 that are not covered by the pixel electrode 191.

A second alignment layer 21 is formed under the common electrode 270 to face the first alignment layer 11.

The first alignment layer 11 and the second alignment layer 21 may be formed of a vertical alignment layer and may be made of an alignment material such as polyamic acid, polysiloxane, and polyimide. The first and second alignment layers 11 and 21 may be connected to each other at an edge of the pixel area PX.

The liquid crystal layer formed of liquid crystal molecules 310 is formed within the microcavity 305 disposed between the pixel electrode 191 and the common electrode 270. The liquid crystal molecules 310 have a negative dielectric anisotropy. That is, the long axis of the liquid crystal molecules may be aligned to be orthogonal the substrate 110 when the liquid crystal molecules are not applied with an electric field. That is, the vertical alignment may be formed.

When the first subpixel electrode 191h and the second subpixel electrode 191l are applied with the data voltage and the common electrode 270 is applied with the common voltage Vcom, an electric field is generated in the liquid crystal layer, which determines the alignment direction of the liquid crystal molecules 310 located within the microcavity 305 between the two electrodes 191 and 270. The luminance of the light transmitted by the liquid crystal layer varies depending on the determined direction of the liquid crystal molecules 310.

A second insulating layer 350 may be further formed on the common electrode 270. The second insulating layer 350 may be made of inorganic insulating materials such as silicon nitride (SiNx), silicon oxide (SiOx), and silicon nitride oxide (SiOxNy) and may be omitted in some cases.

The color filter 230 is formed on the second insulating layer 350. The microcavity 305 and the connection microcavity 306 are formed under the color filter 230, and a shape of the microcavity 305 and the connection microcavity 306 may be maintained. That is, the color filters 230 are formed to be spaced apart the pixel electrode 191, having the microcavity 305 in between.

The color filter 230 may display one of several primary colors such as three primary colors of red, green, and blue. The color filter 230 is not limited to the three primary colors of red, green, and blue and may also display cyan, magenta, yellow, white-based colors, and the like. As illustrated in FIG. 1, the color filter 230 may extend lengthwise in a column direction along and between adjacent data lines 171. Adjacent color filters 230 in a row direction may have different colors and a data line 171 disposed in between. That is, red, green, and blue color filters 230 may be repeatedly present in each pixel area in a row direction.

The color filter 230 is formed in each pixel area PX and the second valley V2 along a pixel row and is formed only in a portion of the first valley V1. That is, in the first valley V1, the color filter 230 is formed only on the connection microcavity 306 between the first subpixel area PXa and the second subpixel area PXb. The microcavity 305 under each color filter 230 is formed in each of the first subpixel area PXa and the second subpixel area PXb. The microcavity 305 is not formed under the color filter 230 in the second valley V2 and is formed to be attached to the substrate 110. An upper surface and both sides of the microcavity 305 are formed to be covered by a color filter 230.

The common electrode 270, the second insulating layer 350, and the color filter 230 are provided with an injection hole 307 through which a portion of the microcavity 305 is exposed. The injection holes 307 may be formed to face each other at the edges of the first subpixel area PXa and the second subpixel area PXb. That is, the injection hole 307 may be formed to expose sides of the microcavity 305, corresponding to a lower side of the first subpixel area PXa and an upper side of the second subpixel area PXb adjacent to the first valley V1. Since the microcavity 305 is exposed by the injection hole 307, an alignment solution, the liquid crystal material, or the like may be injected into the microcavity 305 through the injection hole 307.

The injection hole may be provide in a portion of the microcavity 305 not connected to the connection microcavity 306. For example, as illustrated in FIG. 1, the connection microcavity 306 is positioned to be aligned with the center of the microcavity 305, and the injection holes 307 are formed in the microcavity 305 on both sides of the connection microcavity 306.

A third insulating layer 370 may be further formed on the color filter 230. The third insulating layer 370 may be made of inorganic insulating materials such as silicon nitride (SiNx), silicon oxide (SiOx), and silicon nitride oxide (SiOxNy). The third insulating layer 370 may be formed to cover the upper surface and sides of the color filter 230. The third insulating layer 370 serves to protect the color filter 230, which is made of the organic material. Although a structure in which the third insulating layer 370 is formed on the color filter 230 is described, the present system and method are not limited thereto, and the third insulating layer 370 may be omitted.

An encapsulation layer 390 may be formed on the third insulating layer 370. The encapsulation layer 390 is formed to cover the injection hole 307 and prevent the microcavity 305 from being exposed to the outside. That is, the encapsulation layer 390 may seal the microcavity 305 to prevent the liquid crystal molecules 310 in the microcavity 305 from leaking to the outside. Because the encapsulation layer 390 contacts the liquid crystal molecule 310, and the encapsulation layer 390 may be made of a material that does not react to the liquid crystal molecules 310. For example, the encapsulation layer 390 may be made of parylene, and the like.

The encapsulation layer 390 may also be formed of multilayers such as double layers and triple layers. The double layers may be formed of two layers made of different materials. The triple layer may be formed of three layers in which adjacent layers are made of different materials. For example, the encapsulation layer 390 may include a layer made of an organic insulating material and a layer made of an inorganic insulating material.

Although not illustrated, polarizers may be further formed on the upper and lower surfaces of the display device. The polarizers may include a first polarizer and a second polarizer. The first polarizer may be attached to a lower surface of the substrate 110 and the second polarizer may be attached to an upper surface of the encapsulation layer 390.

As such, according to an exemplary embodiment of the present system and method, the connection microcavity 306 is formed between adjacent microcavities 305 in the column direction to connect the microcavities 305 to each other.

That is, the connection microcavity 306 is formed in the first valley V1 and shares a cavity with the microcavity 305. The connection microcavity 306 prevents the upper color filter 230 from sinking. Particularly, because the alignment layer occurs in the connection microcavity 306, a separate support member does not need to be formed. Therefore, a reduction in an aperture ratio that would otherwise occur due to the presence of a separate support member is prevented. Further, as described below, it is possible to prevent air bubbles from occurring when the liquid crystal material is injected.

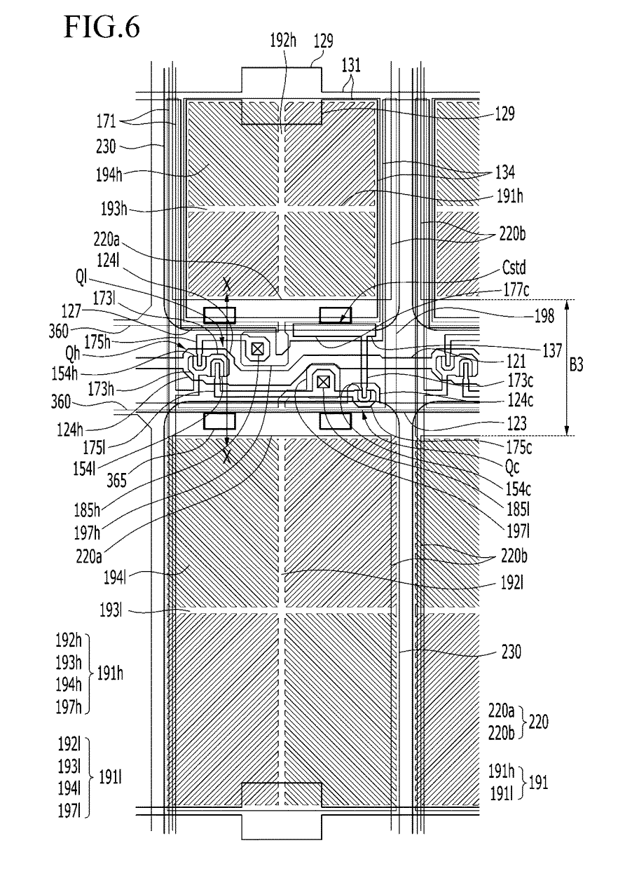

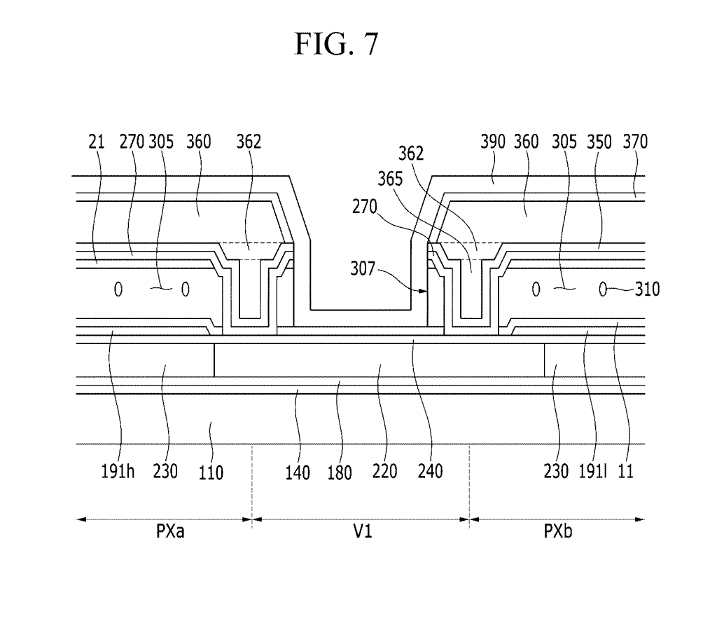

Next, compared with a comparative example, the sinking prevention effect of the color filter 230, a lump prevention effect of the alignment layer, and the aperture ratio improvement effect of the display device according to an exemplary embodiment of the present system and method are described. FIG. 6 is a layout view of a display device according to a comparative example. FIG. 7 is a cross-sectional view of the layout view of FIG. 6 taken along the line VI-VI. Referring to FIG. 6, which shows the display device according to the comparative example, a support member 365 for preventing a roof layer from sinking is positioned in the vicinity of the injection hole of the microcavity. Referring to FIG. 7, the support member 365 is made of a roof layer material and may prevent structures such as the roof layer 360 positioned on the microcavity 305 from sinking. However, the support member 365 increases a capillary force, which causes lumping of the alignment layer to occur in the vicinity of the support member 365. Therefore, the support member 365 is in a region where light is blocked by the black matrix 220, and as illustrated in FIGS. 6 and 7, the width of the black matrix positioned in the first valley is widened. Therefore, the sinking of the roof layer 360 may be prevented, and the lump of the alignment layers may be induced into a non-visible region by forming the support member 365. However, the problem of reduction in the aperture ratio is still present.

Further, in the case of the display device according to the comparative example, the liquid crystal material may leak from the microcavity injection hole at a portion where the support member is not formed.

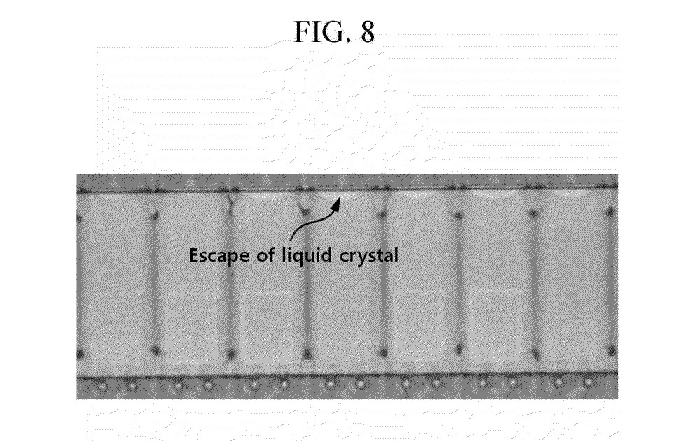

FIG. 8 is an image illustrating a state in which a liquid crystal material escaped from the display device according to the comparative example. A region in which the liquid crystal material escaped is represented by whiter or lighter shading. The liquid crystal material may escape, for example, if the microcavity injection hole at the portion where the support member is not present is opened. In such case, the liquid crystal filled in the microcavity in the vicinity of the microcavity injection hole may be removed during a process in which the residual liquid crystal material is cleaned after the injection of the liquid crystal material.

Further, the display device according to the comparative example may have another problem in which air bubbles are generated during the injecting of the liquid crystal material. FIG. 9 is an image illustrating a state in which air bubbles are generated during the injecting of the liquid crystal material in the display device according to the comparative example.

The liquid crystal material drops to the first valley positioned between the microcavities and enters the microcavities through the injection hole formed in the microcavities. In this case, air previously present in the microcavity does not exit and forms air bubbles. As illustrated in FIG. 9, the air bubbles are visible in a bright color and constitute defects in the display device.

In contrast, in the display device according to an exemplary embodiment of the present system and method, the connection microcavity 306 positioned between the microcavities 305 performs similar functions as the support member of the comparative example without incurring the above-described problems. That is, the connection microcavity 306 supports structures such as the color filter 230 positioned on the microcavity 305 and prevents the color filter 230 from sinking.

Because the width of the connection microcavity 306 is narrower than that of the microcavity 305, the capillary force of the connection microcavity 306 is larger than that of the microcavity 305. Therefore, lumping of the alignment layers is induced into the connection microcavity 306 during the injecting of the alignment layer. Since the connection microcavity 306 is positioned in a region where the light is blocked by the black matrix 220, the lumping of the alignment layers is effectively induced and thus may not be visible.

Further, both sides of the microcavity 305 where the connection microcavity 306 is not formed are opened in the first valley. Therefore, the air previously filled in the microcavity is able to exit through the injection hole present at an opposite side of where the liquid crystal material is being injected, and thus, air bubbles are not formed.

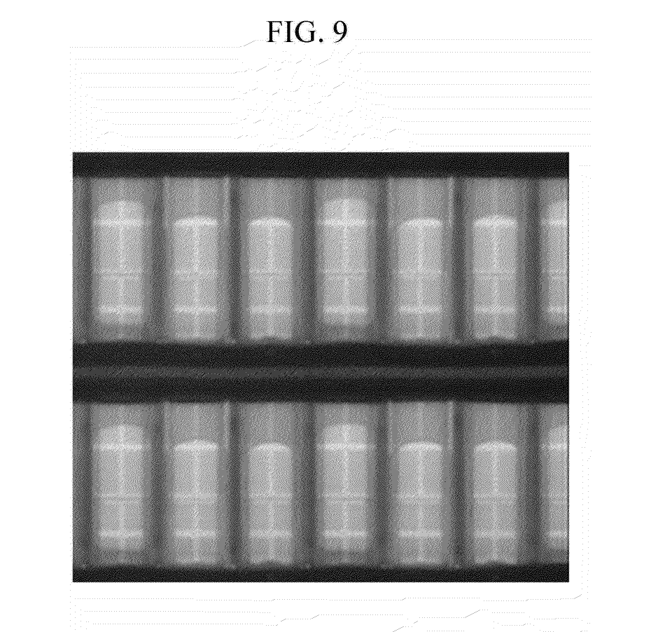

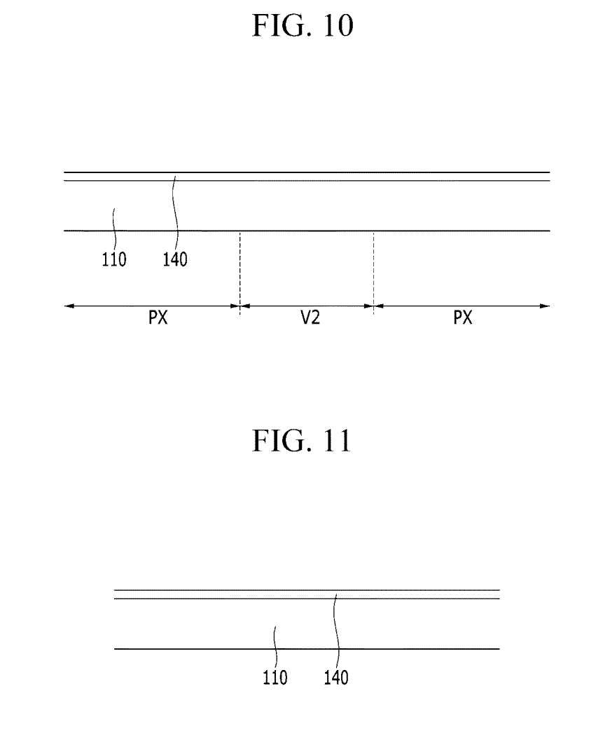

Next, a manufacturing method of a display device according to an exemplary embodiment of the present system and method are described below with reference to FIGS. 1 to 5, and 10 to 35. FIGS. 10 to 35 are process cross-sectional diagrams and schematic diagrams illustrating a manufacturing process of the display device according to an exemplary embodiment of the present system and method.

FIGS. 10, 12, 14, 16, 18, 21, 22, and 23 are process cross-sectional views of a surface of the display device of FIG. 1 taken along the line V-V. FIGS. 11, 13, 15, 17, 19, 25, 27, and 29 are process cross-sectional views of a surface of the display device of FIG. 1 taken along the line XI-XI. That is, FIGS. 11, 13, 15, 17, 19, 25, 27, and 29 are cross-sectional views of the connection microcavity.

FIGS. 24, 26, 28, and 30 are process cross-sectional views of a surface of the display device of FIG. 1 taken along the line III-III.

As illustrated in FIG. 10, a substrate 110, which may be made of glass, plastic, or the like, is formed. The gate line 121 and the step down gate line 123, which extend in the same direction (e.g., see FIG. 2), are formed on the substrate 110. The first gate electrode 124h, the second gate electrode 124l, and the third gate electrode 124c, which protrude from the gate line 121, are also formed on the substrate 110.

Further, the gate line 121, the step down gate line 123, and the sustain electrode line 131 spaced apart from the first to third gate electrodes 124h, 124l, and 124c may be formed together.

Next, the gate insulating layer 140 made of inorganic insulating materials such as silicon oxide (SiOx) or silicon nitride (SiNx) is formed on an upper surface of the substrate 110, covering the gate line 121, the step down gate line 123, the first to third gate electrodes 124h, 124l, and 124c, the sustain electrode line 131. The gate insulating layer 140 may be formed of a single layer or multilayers.

In this case, as illustrated in FIG. 11, the gate insulating layer is formed even in the first valley.

Next, semiconductor materials, such as amorphous silicon, polycrystalline silicon, and metal oxide, are deposited on the gate insulating layer 140 and then patterned to form the first semiconductor 154h, the second semiconductor 154l, and the third semiconductor 154c. The first semiconductor 154h may be formed to be positioned on the first gate electrode 124h. The second semiconductor 154l may be formed to be positioned on the second gate electrode 124l. The third semiconductor 154c may be formed to be positioned on the third gate electrode 124c.

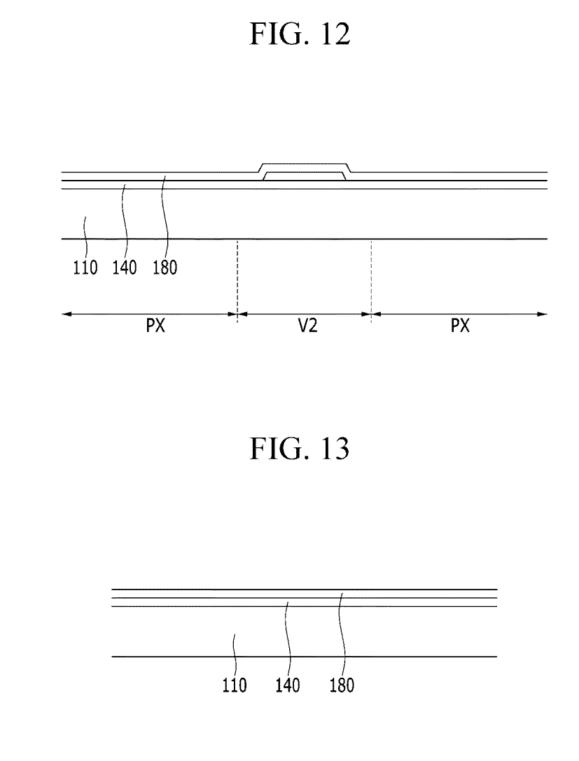

Next, referring to FIG. 12, a metal material is deposited and then patterned to form the data line 171, which extends in a direction crossing the gate line 121. The metal material may be formed of a single layer or multilayers.

Further, the first source electrode 173h protruding over the first gate electrode 124h from the data line 171 and the first drain electrode 175h spaced apart from the first source electrode 173h are formed together. Further, the second source electrode 173l connected to the first source electrode 173h and the second drain electrode 175l spaced apart from the second source electrode 173l are formed together. Further, the third source electrode 173c extending from the second drain electrode 175l and the third drain electrode 715c spaced apart from the third source electrode 173c are formed together.

The semiconductor material and the metal material may be continuously deposited and then simultaneously patterned to form the first to third semiconductors 154h, 154l, and 154c, the data line 171, the first to third source electrodes 173h, 173l, and 173c, and the first to third drain electrodes 175h, 175l, and 175c. In this case, the first semiconductor 154h is formed by extending below the data lines 171.

The first/second/third gate electrodes 124h/124l/124c, the first/second/third source electrodes 173h/173l/173c, and the first/second/third drain electrodes 175h/175l/175c, along with the first/second/third semiconductors 154h/154l/154c, configure the first/second/third thin film transistors (TFTs) Qh/Ql/Qc, respectively.

Next, the passivation layer 180 is formed on the data line 171, the first to third source electrodes 173h, 173l, and 173c, the first to third drain electrodes 175h, 175l, and 175c, and portions of the semiconductors 154h, 154l, and 154c respectively exposed between the source electrodes 173h/173l/173c and the drain electrode 175h/175l/175c. The passivation layer 180 may be made of an organic insulating material or an inorganic insulating material and may be formed of a single layer or multilayers.

In this case, as illustrated in FIG. 13, the passivation layer 180 is also formed even in the first valley.

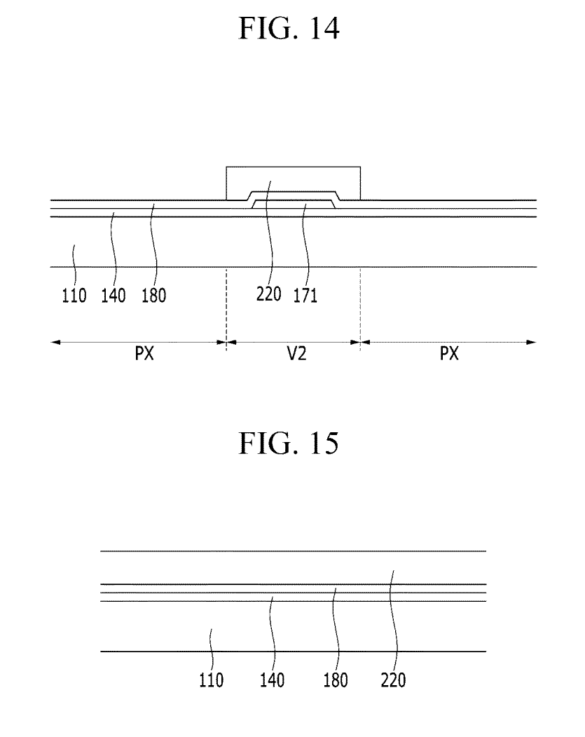

Next, referring to FIG. 14, the boundary part of each pixel area PX is formed on the passivation layer 180, and the light blocking member 220 is formed on the thin film transistor. In this case, as illustrated in FIG. 15, the light blocking member 220 may be formed even in the first valley, which is positioned between the subpixel area PXa and the second subpixel area PXb.

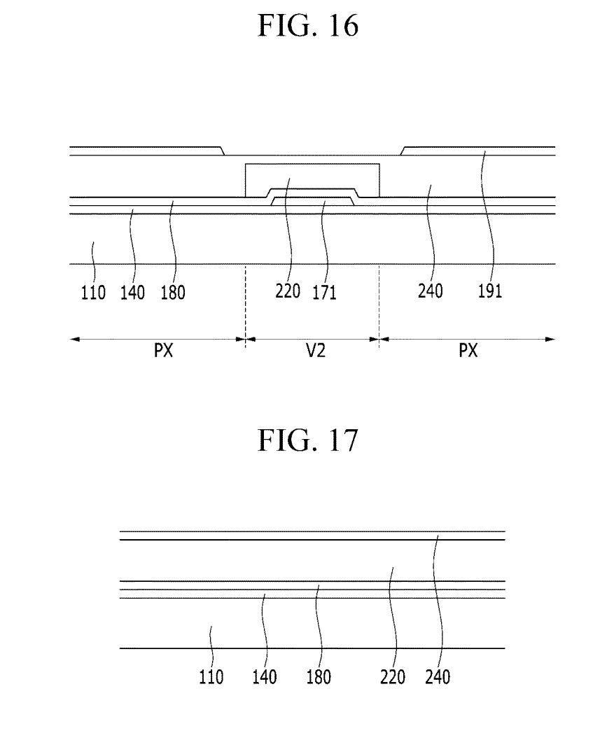

Next, referring to FIG. 16, the first insulating layer 240 made of inorganic insulating materials, such as silicon nitride (SiNx), silicon oxide (SiOx), and silicon nitride oxide (SiOxNy), is formed on the light blocking member 220. In this case, as illustrated in FIG. 17, the first insulating layer 240 is formed even in the first valley.

Next, the passivation layer 180, the light blocking member 220, and the first insulating layer 240 are etched to form the first contact hole 185h through which a portion of the first drain electrode 175h is exposed and the second contact hole 185l through which a portion of the second drain electrode 175l is exposed.

Next, transparent metal materials, such as indium tin oxide (ITO) and indium zinc oxide (IZO), are deposited on the first insulating layer 240 and then patterned to form the first subpixel electrode 191h in the first subpixel area PXa and form the second subpixel electrode 191l in the second subpixel area PXb. The first subpixel electrode 191h and the second subpixel electrode 191l are separated from each other by the first valley V1 disposed in between. The first subpixel electrode 191h is formed to be connected to the first drain electrode 175h through the first contact hole 185h. The second subpixel electrode 191h is formed to be connected to the second drain electrode 175l through the second contact hole 185l.

The first subpixel electrode 191h and the second subpixel electrode 191l are each formed with the horizontal stem parts 193h and 193l and the vertical stem parts 192h and 192l which intersect the horizontal stem parts 193h and 193l, respectively. Further, the plurality of fine branch parts 194h and 194l that obliquely extend from the horizontal stem parts 193h and 193l and the vertical stem parts 192h and 192l, respectively, are formed.

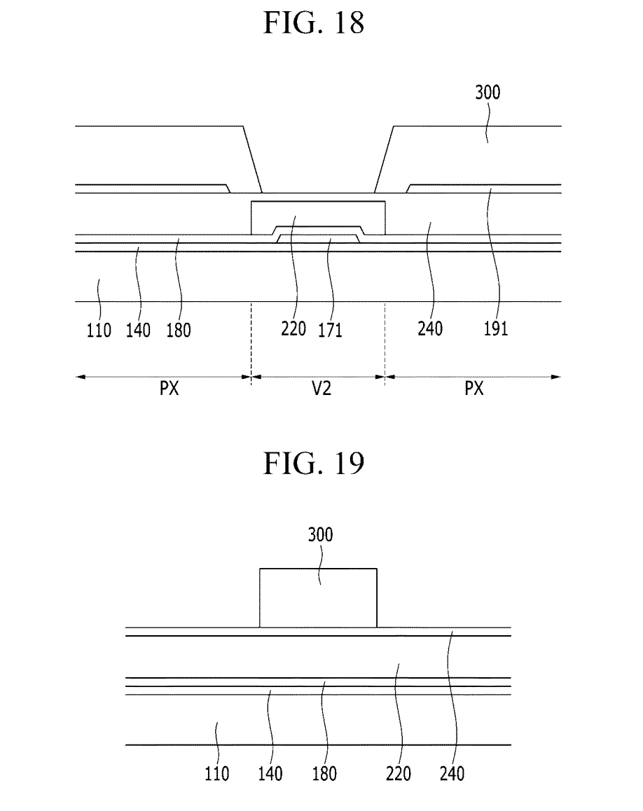

Next, as illustrated in FIG. 18, a photosensitive organic material is applied on the pixel electrode 191, and sacrificial layers 300 are formed by a photo process. The sacrificial layer 300 may be made of a positive photosensitive material.

The sacrificial layers 300 are formed to be connected to each other along the plurality of pixel columns. That is, the sacrificial layer 300 is formed to cover each pixel area PX and is also formed to cover a portion of the first valley V1 positioned between the first subpixel area PXa and the second subpixel area PXb. However, the sacrificial layer on the second valley V2 is removed by the photo process and thus is not present on the second valley V2.

That is, the sacrificial layer 300 is formed to be connected along the plurality of pixel columns and has a narrower width in the first valley. As illustrated in FIG. 19, the width of the sacrificial layer formed in the first valley is narrower than that of the sacrificial layer which is formed in the pixel area PX. The reason is that the spaces in which the sacrificial layers are positioned each are the microcavity and the connection microcavity. That is, the width of the sacrificial layer of the pixel area may be two to four times as large as that of the sacrificial layer formed in the first valley V1.

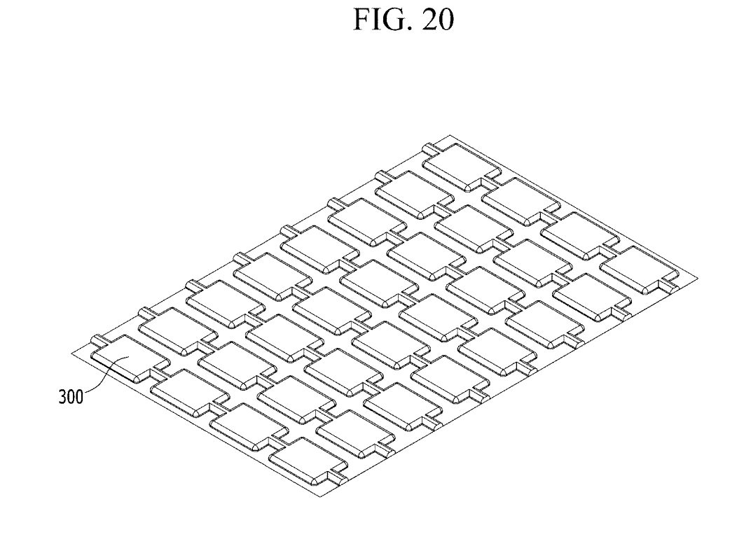

FIG. 20 is a diagram illustrating a form of a sacrificial layer over a substrate according to an exemplary embodiment of the present system and method. Referring to FIG. 20, the sacrificial layers are formed to be connected to each other in the column direction, the width thereof is narrow in the first valley V1, and the sacrificial layers are not present in the second valley.

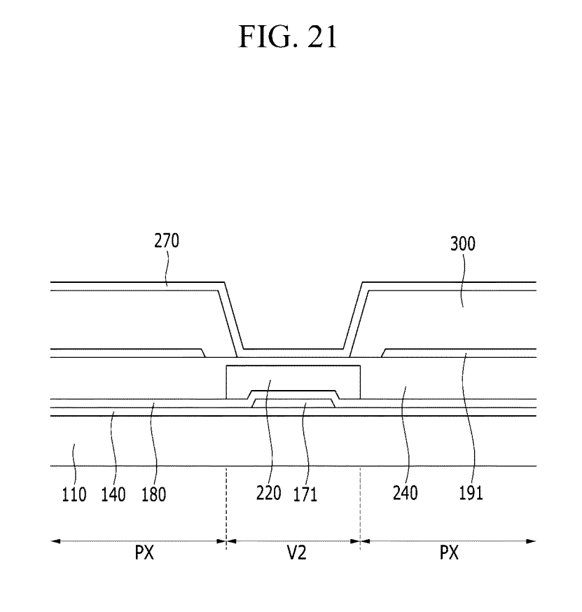

Next, as illustrated in FIG. 21, transparent metal materials, such as indium tin oxide (ITO) and indium zinc oxide (IZO), are deposited on the sacrificial layer 300 to form the common electrode 270.

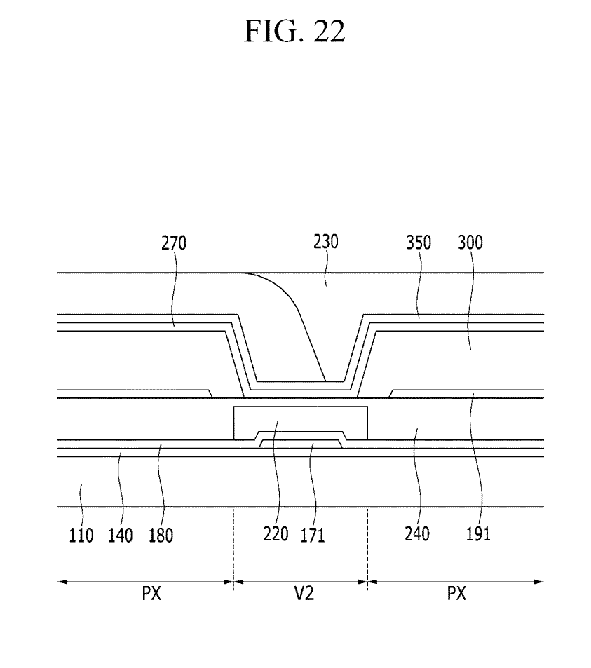

Next, as illustrated in FIG. 22, the second insulating layer 350 made of inorganic insulating materials, such as silicon nitride (SiNx), silicon oxide (SiOx), and silicon nitride oxide (SiOxNy), is formed on the common electrode 270.

Next, the color filter 230 is formed on the second insulating layer 350. In this case, the color filters 230 are formed in the first subpixel area PXa and the second subpixel area PXb, respectively, and may also be formed in the first valley V1 having a narrow width. Further, the color filters 230 having the same color may be formed along the column direction of the plurality of pixel areas PXs. That is, the same color filter may be formed in the column direction of the plurality of pixel areas PXs, and the color filter having three colors of RGB may be alternately formed in the row direction thereof. When the color filters 230 having three colors are formed, the color filter 230 of a first color may be first formed and then a mask may be shifted to form the color filter 230 having a second color. Next, after the color filter 230 having the second color is formed, the mask may be shifted to form the color filter 230 having a third color.

In this case, a portion of the color filter 230 formed in the first valley V1 is patterned. That is, in the first valley, the color filter 230 of the region in which the sacrificial layer 300 is not formed is removed. In this case, the region of the patterned color filter 230 serves as the liquid crystal injection hole later.

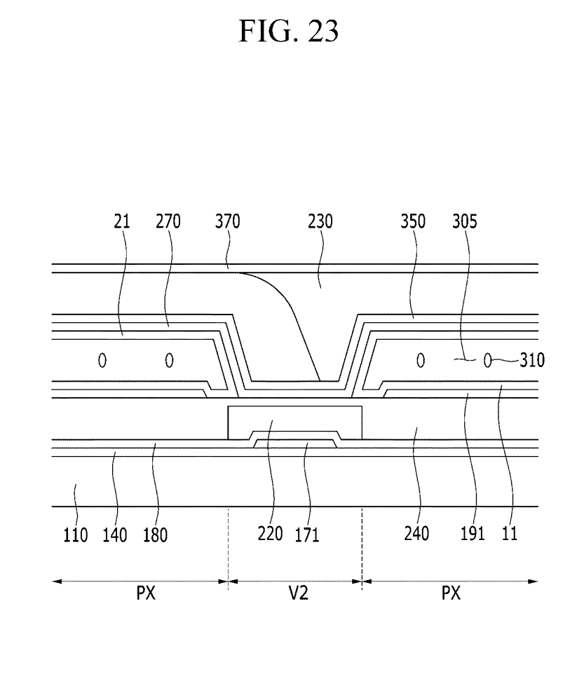

Next, as illustrated in FIG. 23, the third insulating layer 370 made of inorganic insulating materials, such as silicon nitride (SiNx), silicon oxide (SiOx), may be formed on the color filter 230. The third insulating layer 370 is formed on the patterned color filter 230 and therefore may cover the side of the color filter 230 to protect the color filter 230.

FIG. 24 illustrates another cross section of the display device manufactured by the steps illustrated in FIG. 23. Particularly, FIG. 24 illustrates a cross-section including the region of the first valley V1.

FIG. 23 illustrates a cross section of a region including the second valley V2, but for better comprehension and convenience of description, the cross section of the region including the first valley V1 is described below.

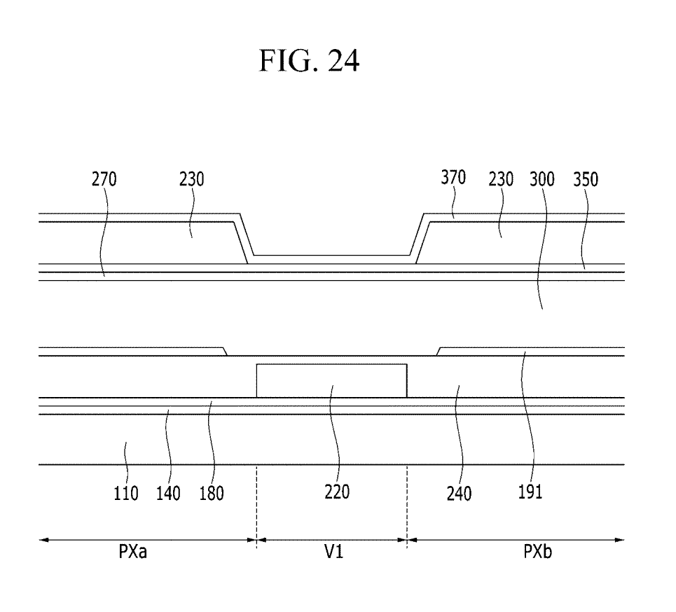

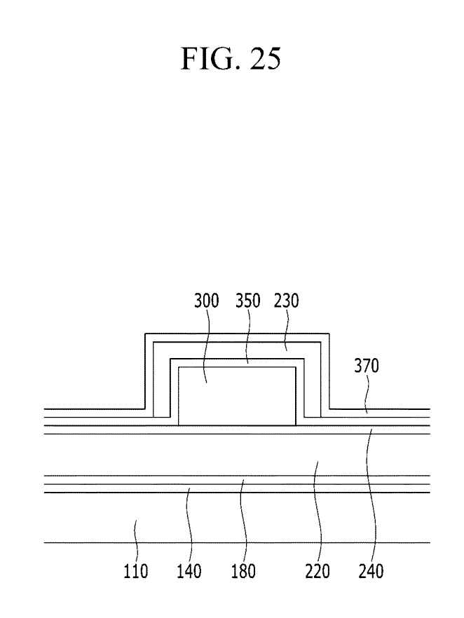

Referring to FIG. 25, the color filter 230 and the third insulating layer 370 are also stacked on the first valley V1.

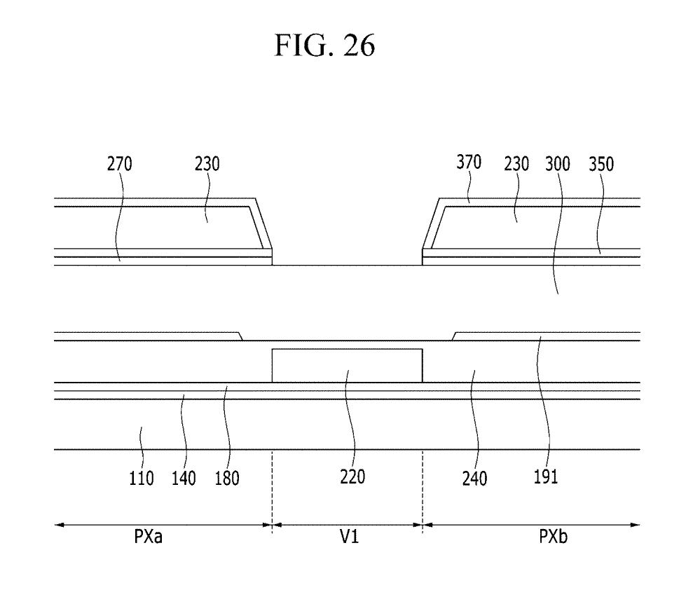

Next, referring to FIG. 26, portions of the third insulating layer 370, the second insulating layer 350, and the common electrode 270 positioned in the first valley V1 are removed by patterning the third insulating layer 370, the second insulating layer 350, and the common electrode 270. As the third insulating layer 370, the second insulating layer 350, and the common electrode 270 are patterned, the sacrificial layer 300 positioned in the first valley V1 becomes exposed.

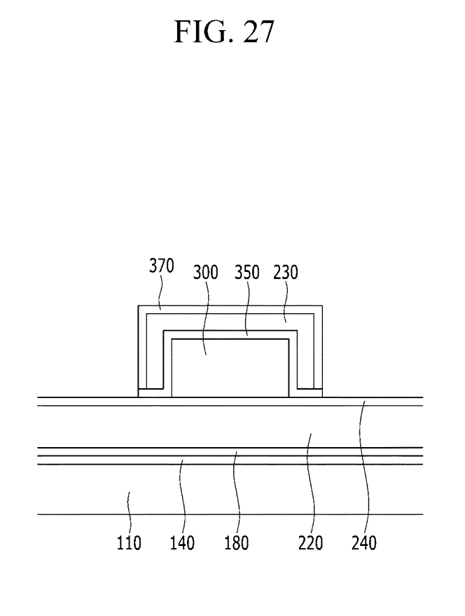

In this case, referring to FIG. 27, the third insulating layer 370 and the second insulating layer 350 are patterned even in the structure stacked in the first valley V1. Therefore, the sacrificial layer 300, the second insulating layer 350 on the sacrificial layer 300, the color filter 230 on the second insulating layer, and the third insulating layer 370 on the color filter 230 are sequentially present in the first valley, and both sides of the sacrificial layer 300 and the color filter 230 are each protected by the insulating layer, and the like. That is, the sacrificial layer 300 and the color filter 230 are not exposed in the horizontal direction of the first valley.

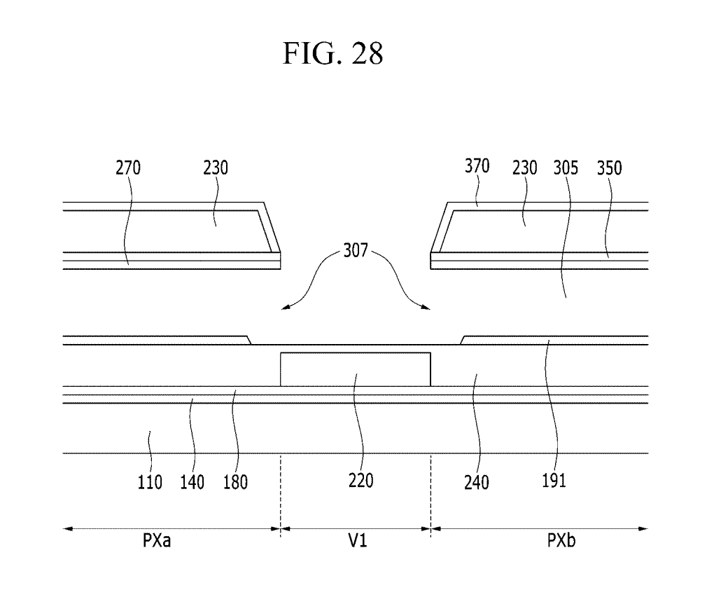

Next, referring to FIG. 28, the sacrificial layer 300 is ashed by supplying oxygen plasma on the substrate 110 on which the sacrificial layer 300 is exposed, or the whole surface of the sacrificial layer 300 is removed by supplying a developer. When the sacrificial layer 300 is removed, the microcavity 305 is generated in the space where the sacrificial layer 300 is removed.

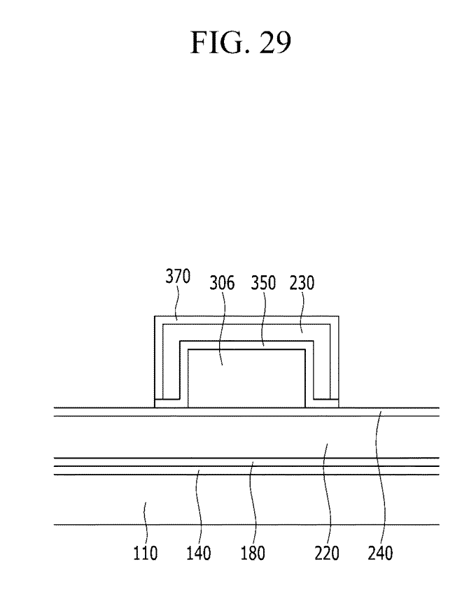

In this case, the patterned sacrificial layer 300 exposed in the pixel area is removed. Although both sides of the patterned sacrificial layer are not exposed in the first valley V1, because the sacrificial layer of the pixel area and the sacrificial layer of the first valley are connected to each other, the sacrificial layer of the first valley is also removed. Therefore, as illustrated in FIG. 29, the connection microcavity 306 is generated in the space where the sacrificial layer 300 is removed. The microcavity 305 and the connection microcavity 306 are formed together by removing the sacrificial layer 300, and therefore the microcavity 305 and the connection microcavity 306 are connected to each other.

As illustrated in FIG. 28, the pixel electrode 191 and the common electrode 270 are spaced apart from each other with the microcavity 305 disposed in between. Similarly, the pixel electrode 191 and the color filter 230 are spaced apart from each other with the microcavity 305 disposed in between. The common electrode 270 and the color filter 230 are formed to cover the upper surface and both sides of the microcavity 305 adjacent to the second valleys V2.

The microcavity 305 is exposed to the outside through the portions where the color filter 230 and the common electrode 270 are removed, thereby forming liquid crystal injection holes 307. The liquid crystal injection holes 307 are formed along the first valley V1. According to another embodiment, the liquid crystal injection hole 307 may be formed along the second valley V2.

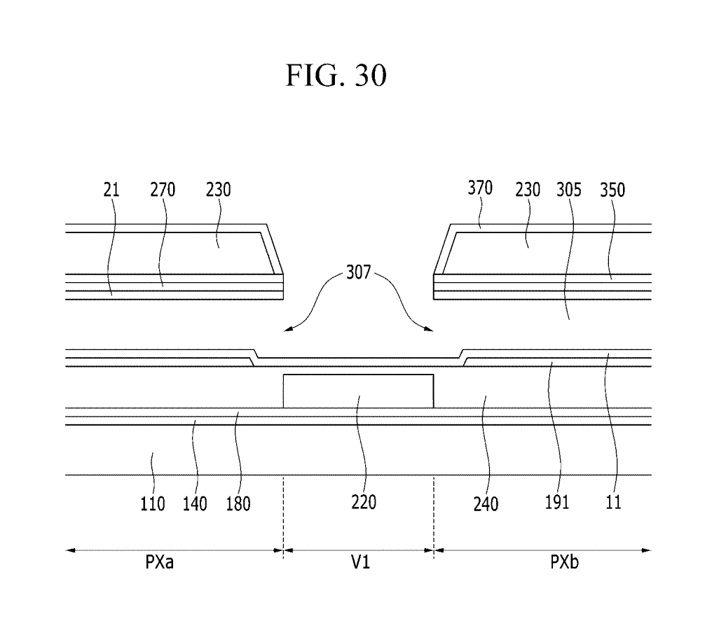

Next, referring to FIG. 30, when the alignment solution including the alignment material is dropped on the substrate 110 by a spin coating method or an inkjet method, the alignment solution is injected into the microcavity 305 through the injection hole 307. After the alignment solution is injected into the microcavity 305, a hardening process is used to evaporate a solution ingredient, while the aligning material remains on a wall surface in the microcavity 305.

That is, after the hardening process, the first alignment layer 11 is formed on the pixel electrode 191, and the second alignment layer 21 may be formed under the first common electrode 270. The first alignment layer 11 and the second alignment layer 21 are formed to face each other with the microcavity 305 disposed in between and are connected to each other at the edges of the pixel area PX.

In this case, the first and second alignment layers 11 and 21 may be aligned in the vertical direction to the substrate 110 other than the side of the microcavity 305. In addition, a process of irradiating UV to the first and second alignment layers 11 and 21 may be used to align the first and second alignment layers 11 and 21 in the horizontal direction to the substrate 110.

In this case, since the microcavity 305 and the connection microcavity 306 are connected to each other, the alignment solution injected through the injection hole formed in the microcavity 305 is also injected into the connection microcavity 306.

In this case, since the width of the connection microcavity 306 is narrower than that of the microcavity 305, the capillary force is stronger. As a result, lumping of the alignment layers is induced into the connection microcavity 306 when the alignment solution is hardened. That is, the lumping of the alignment layers may appear in some regions while the alignment solution is hardened. However, according to the exemplary embodiment of the present system and method, the lumping of the alignment layers is induced into the connection microcavity 306, thereby solving the above problem.

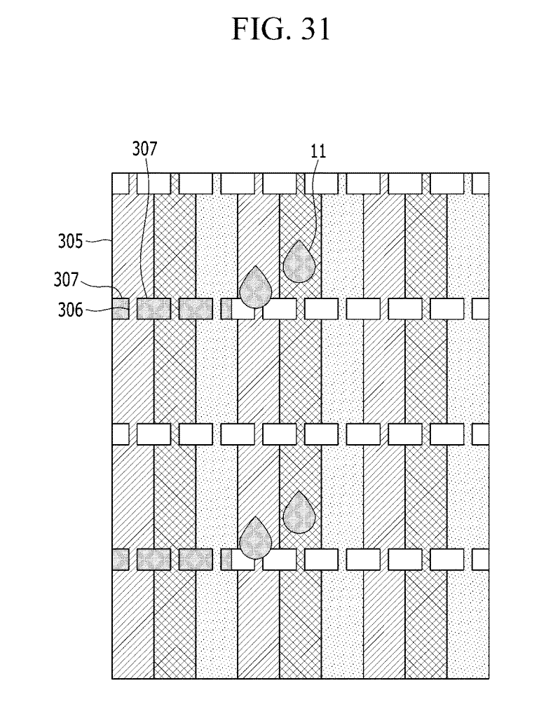

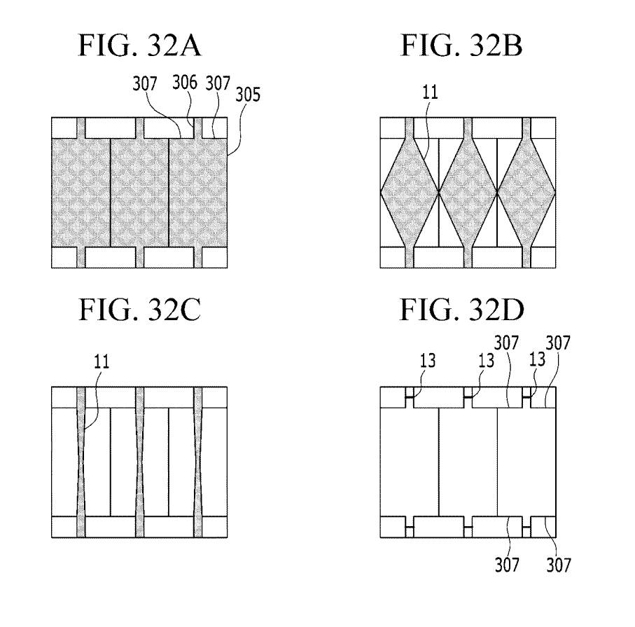

FIGS. 31 and 32 are diagrams illustrating a process of applying an alignment solution, drying an alignment layer, and inducing lumping of the alignment layer in a manufacturing method of a display device according to an exemplary embodiment of the present system and method.

Referring to FIG. 31, the alignment solution is dropped into every other first valley V1 (i.e., skipping one each time). The applied alignment solution fills the microcavity 305 through the injection hole 307 the microcavity 305 and the connection microcavity 306 connected thereto.

FIG. 32A illustrates a dry process in the microcavity 305 and the connection microcavity 306 in which the alignment solution is filled. FIGS. 32B to 32D illustrate a process of drying the alignment solution. Referring to FIG. 32B, the alignment solution starts to be dried from the edge of the microcavity 305. Next, as illustrated in FIG. 32C, the alignment solution dries inward towards the center of the microcavity 305. Next, as illustrated in FIG. 32D, the alignment solution is dried over the whole region of the microcavity 305. However, as illustrated in FIG. 32D, because the width of the connection microcavity is narrower than that of the microcavity 305, the capillary force is stronger and causes a large amount of alignment solution to be injected into the connection microcavity. As a result, lumping of the alignment layers may occur at the time of the drying. That is, the lumps 13 of the alignment solutions occur in the connection microcavity 306 and do not occur in the microcavity 305. The connection microcavity 306 is a region covered by the black matrix 220. Therefore, even though the lumps 13 of the alignment layers occur, they do not affect the display quality. As such, defects due to lumping of the alignment layers may be solved according to an embodiment of the present system and method.

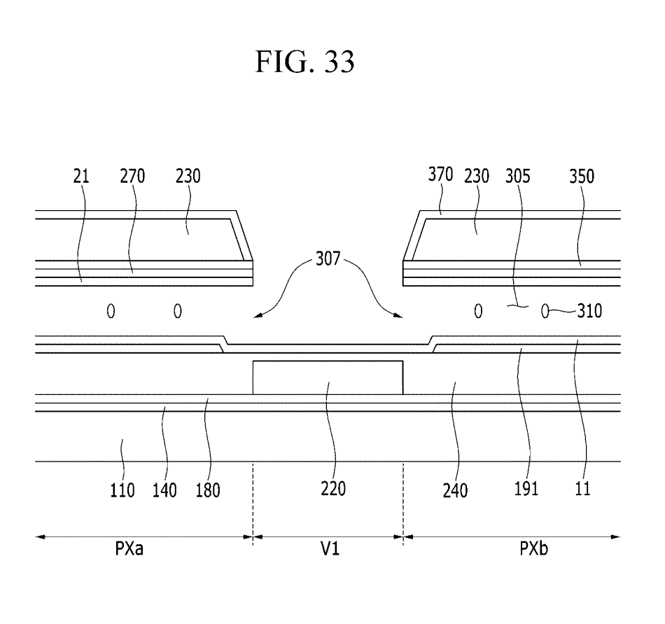

Next, referring to FIG. 33, when the liquid crystal material formed of the liquid crystal molecules 310 is dropped on the substrate 110 by an inkjet method or a dispensing method, the liquid crystal material is injected into the microcavity 305 through the injection hole 307. In this case, the liquid crystal material may be dropped into the injection holes 307 formed along every other first valley V1 (e.g., dropped into the odd numbered first valleys V1 and not into injection holes 307 formed along even numbered first valleys V1, or dropped into the even numbered first valleys V1 and not dropped into the injection holes 307 formed along the odd numbered first valleys V1).

When the liquid crystal material is dropped into the injection holes 307 formed along the odd numbered first valleys V1, the liquid crystal material enters the microcavity 305 through the injection hole 307 by capillary force. In this case, the air in the microcavity 305 exits through the injection holes 307 formed along the even numbered first valleys V1, which allows the liquid crystal material to enter the microcavity 305 more easily. Further, since the microcavity 305 is connected to the connection microcavity 306, the liquid crystal also enters the connection microcavity 306.

In this case, as described above, the liquid crystal material is selectively dropped into only the odd numbered or even numbered injection holes so that air can exit through the injection holes at the opposite side when the liquid crystal material is injected. Doing so prevents air bubbles from forming.

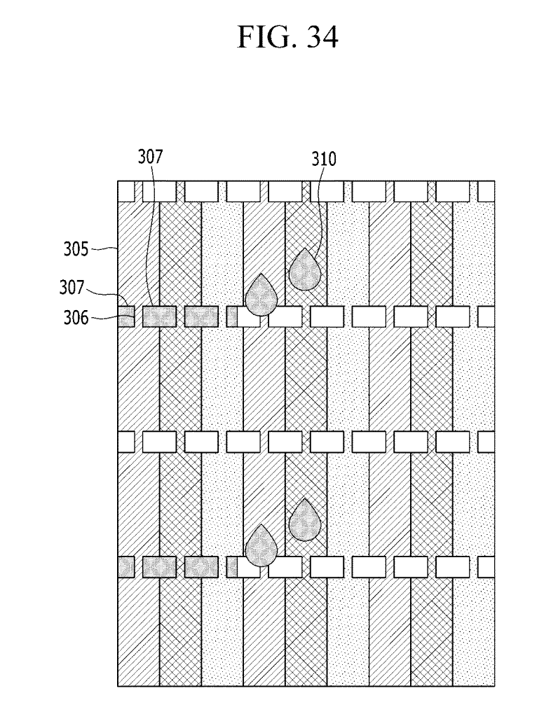

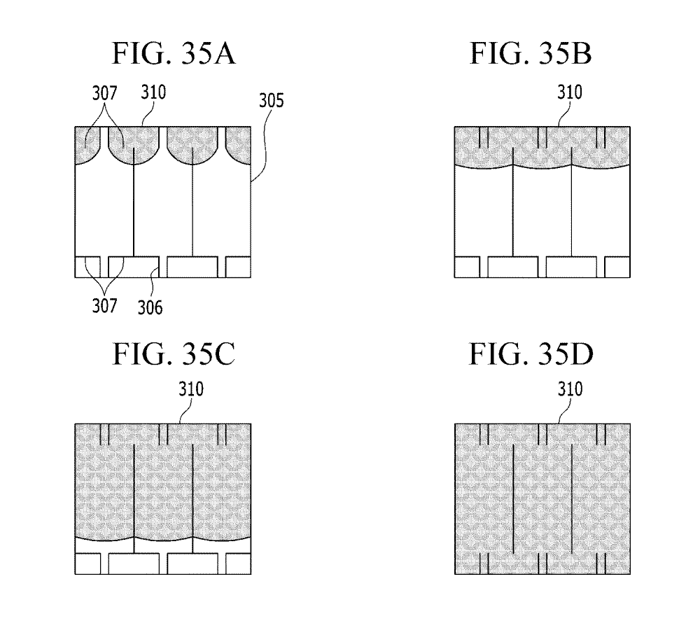

FIGS. 34 and 35 are diagrams illustrating a process of injecting a liquid crystal material in the manufacturing method of a display device according to an exemplary embodiment of the present system and method.

Referring to FIG. 34, the liquid crystal material 310 is dropped into every other first valley (i.e., skipping one each time). That is, the liquid crystal material 310 may be selectively dropped only into the odd numbered first valleys or the even numbered first valleys.

FIG. 35 stepwise illustrates a process of injecting a liquid crystal material. As illustrated in FIG. 35, the injected liquid crystal material slowly extends toward the injection hole at the opposite side to fill the microcavity 305. In this case, the liquid crystal material is not dropped into the injection hole at the opposite side so that the air that previously filled the microcavity 305 is allowed to exit through the injection hole at the opposite side. Therefore, the liquid crystal 310 may fill the microcavity 305 while pushing air to the opposite side, thereby preventing air bubbles from forming in the microcavity 305.

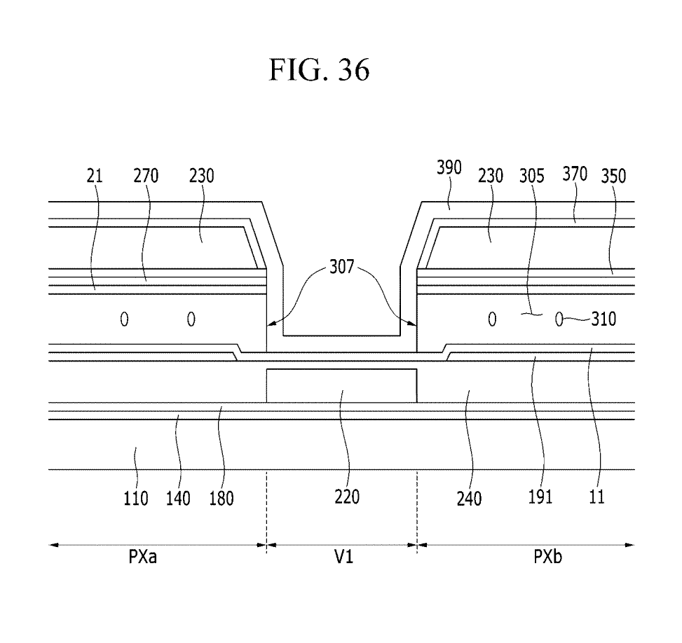

Next, as illustrated in FIG. 36, a material that does not react to the liquid crystal molecule 310 is deposited on the third insulating layer 370 to form the encapsulation layer 390. The encapsulation layer 390 is formed to cover the injection holes 307 through which the microcavity 305 would otherwise be exposed to the outside and to seal the microcavity 305.

Next, although not illustrated, the polarizers may be further formed on the upper and lower surfaces of the display device. The polarizer may be formed of the first polarizer and the second polarizer. The first polarizer may be attached to the lower surface of the substrate 110, and the second polarizer may be attached to the upper surface of the encapsulation layer 390.

As described above, in a display device according to an exemplary embodiment of the present system and method, microcavities 305 adjacent in the column direction of each pixel area are connected to each other by the connection microcavity 306, thereby preventing the structures, such as the color filter 230, positioned on the microcavity from sinking. Further, lumping of the alignment layers is induced into the connection microcavity 306 so that lumping does not occur in the microcavities 305, thereby preventing defects due to the lump of the alignment layers in the display area. Further, the liquid crystal is injected only into the odd numbered or even numbered injection holes to allow the air in the microcavities 305 to exit through the injection hole at the opposite side, thereby preventing air bubbles from forming when the liquid crystal material is injected.

While present system and method are described in connection with one or more exemplary embodiments, the present system and method are not limited to the disclosed embodiments. Various modifications and equivalent arrangements may be made by those of ordinary skill in the art without departing from the spirit and scope of the present system and method.

<Description of symbols>

| 11: First alignment layer | 21: Second alignment layer |
|---|---|
| 110: Substrate | |
| 121: Gate line | 123: Step down gate line |
| 124h: First gate electrode | 124l: Second gate electrode |
| 124c: Third gate electrode | 131: Sustain electrode line |
| 140: Gate insulating layer | 154h: First semiconductor |
| 154l: Second semiconductor | 154c: Third semiconductor |
| 171: Data line | 173h: First source electrode |
| 173l: Second source electrode 173c: Third source electrode | |
| 175h: First drain electrode | 175l: Second drain electrode |
| 175c: Third drain electrode | 180: Passivation layer |
| 191: Pixel electrode | 191h: First subpixel electrode |
| 191l: Second subpixel electrode | 220: Light blocking member |
| 230: Color filter | 240: First insulating layer |
| 270: Common electrode | 300: Sacrificial layer |
| 305: Microcavity | 306: Connection Microcavity |
| 307: Injection hole | 310: Liquid crystal molecule |
| 350: Second insulating layer | 370: Third insulating layer |
| 390: Encapsulation layer | |

What is claimed is:

1. A display device, comprising:
a substrate including a plurality of pixel areas and a thin film transistor region;
a plurality of thin film transistors formed on the substrate;
a pixel electrode formed in each of the pixel areas and connected to a corresponding thin film transistor;
a color filter layer formed on the pixel electrode to be spaced apart from the pixel electrode by a microcavity disposed in between;
a plurality of connection microcavities formed in the thin film transistor region and connecting microcavities in a column; and
a liquid crystal material filling the microcavities and the connection microcavities.

2. The display device of claim 1, wherein:
the plurality of pixel areas each include a plurality of microcavities, and
the plurality of microcavities are each spaced apart from each other by at least one of a first valley formed in an extending direction of a gate line and a second valley formed in an extending direction of a data line.

3. The display device of claim 2, wherein:
the connection microcavities are formed only in the first valley.

4. The display device of claim 3, wherein:
a width of a connection microcavity is ½ to ¼ of a width of a microcavity, and the widths are measured along a direction in which the first valley extends.

5. The display device of claim 1, wherein:
a side of a microcavity not connected to a connection microcavity is provided with an injection hole.

6. The display device of claim 1, further comprising:
an alignment layer formed in the microcavities.

7. The display device of claim 6, wherein:
the alignment layer is lumped in the connection microcavities.

8. The display device of claim 1, further comprising:
a common electrode formed under the color filter layer, and
wherein the common electrode is spaced apart from the pixel electrode by the microcavity disposed in between.

9. The display device of claim 1, wherein:
a region where a connection microcavity is formed is provided with a light blocking member.

10. The display device of claim 1, wherein:
the color filter layer includes a plurality of color filters in which:
color filters formed in a column have the same color and are formed over microcavities that are connected to each other, and
adjacent color filters formed in a row have different colors and are formed over microcavities that are not connected to each other.

11. A manufacturing method of a display device, comprising:
forming a plurality of thin film transistors on a substrate;
forming a first insulating layer on the thin film transistors;
forming a plurality of pixel electrodes on the first insulating layer, each pixel electrode connected to a corresponding one of the thin film transistors;
forming a sacrificial layer on the pixel electrodes, the sacrificial layer includes a plurality of column portions each having a wide width and a narrow width repeated in a column direction of the substrate and formed to be separated from each other in a row direction,
forming a color filter layer on the sacrificial layer;
forming a liquid crystal injection hole to expose the sacrificial layer by patterning the color filter layer;
forming a microcavity between each of the pixel electrodes and the color filter layer by removing the sacrificial layer and forming a connection microcavity in a region where the pixel electrodes are not formed;
forming an alignment layer by injecting an alignment layer material into the microcavities;
forming a liquid crystal layer by injecting a liquid crystal material into the microcavities; and
sealing the microcavities by forming an encapsulation layer on the color filter layer,
wherein the microcavities positioned in a column are connected to each other by the connection microcavity.

12. The manufacturing method of claim 11, wherein:
the microcavities are each spaced apart from each other by at least one of a first valley formed in an extending direction of a gate line and a second valley formed in an extending direction of a data line, and
the connection microcavity connects the microcavities that are formed adjacent to each other in a column direction and is formed in the first valley.

13. The manufacturing method of claim 11, wherein:
the narrow width of the sacrificial layer is ½ to ¼ of the wide width of the sacrificial layer.

14. The manufacturing method of claim 12, wherein:
a width the connection microcavity is ½ to ¼ of a width of the microcavity, and the widths are measured along a direction in which the first valley extends.

15. The manufacturing method of claim 11, wherein:
in the forming of the alignment layer by injecting the alignment layer material into the microcavities, the alignment layer material injected into the microcavity flows in the connection microcavity.

16. The manufacturing method of claim 15, wherein:
the forming of the alignment layer by injecting the alignment layer material into the microcavity includes hardening the alignment layer material after injecting the alignment layer material, and
the alignment layer is lumped in the connection microcavity.

17. The manufacturing method of claim 11, wherein:
in the forming of the color filter layer on the sacrificial layer, color filters having the same color are formed on the sacrificial layers connected in the column direction, and
the color filters having different colors are formed on adjacent sacrificial layers in the row direction.

18. The manufacturing method of claim 12, wherein:
in the forming of the liquid crystal layer by injecting the liquid crystal material into the microcavities, the liquid crystal material is injected along the row direction of the microcavities arranged in a matrix direction, and
the liquid crystal material is dropped into either even numbered first valleys or odd numbered first valleys.
